(19) United States
(12) Patent Application Publication
(10) Pub. No.: US 2007/0258464 A1
(43) Pub. Date: Nov. 8, 2007

(54) Method and system for IP addressing

(76) Inventors: Dan Hall, Sudbury, MA (US); Michael Loomis, Greenland, NH (US)

Correspondence Address: PEARNE & GORDON LLP, 1801 EAST 9TH STREET, SUITE 1200, CLEVELAND, OH, 44114-3108, US

(21) Appl. No.: 11/429,127

(22) Filed: May 5, 2006

(51) Int. Cl. H04L 12/56; H04L 12/28

(52) U.S. Cl. 370/395.52; 370/401

(57) ABSTRACT

A method and system for IP addressing is provided. A home network user receives a plurality of broadband services from a broadband network through a gateway device. The gateway device obtains a single IP address to allow the home network to receive a plurality of broadband services through a single IP interface.

### FIELD OF INVENTION

The present invention relates to communications network technologies, and more specifically to an IP addressing scheme.

### BACKGROUND OF THE INVENTION

Today's broadband services can be generalized as a single service offer, namely a High Speed Internet service. To implement this service, a service provider has a single Layer 0/Layer 1(L0/L1) connection to a home, typically through some form of broadband such as Digital Subscriber Line (DSL) over copper or a cable data service. These broadband connections carry a single Layer 2 (L2) circuit. For example, DSL uses ATM Permanent Virtual Circuits (PVCs) as this L2 circuit, while cable uses Ethernet. The L2 circuit is terminated in the home and the resulting IP interface is assigned a single public IP address.

FIGS. 1 and 2 illustrate conventional home network architectures for providing a single broadband service, such as High Speed Internet access, to a home device. Referring to FIG. 1, a personal computer (PC) 4 on a home network accesses the broadband service through a Residential Broadband Gateway (RBG) 6. The PC 4 communicates with RBG 6 using a local connection 8 (e.g. Ethernet). The RBG 6 communicates with the broadband network over a Wide Area Network (WAN) connection 10. The RBG 6 may include modem devices, such as a DSL modem or a cable modem. The WAN connection 10 may be implemented by a DSL or cable service. The RBG 6 may also include a home networking device (not shown) such as an Ethernet switch to provide connectivity between multiple devices within the home. However, as shown in FIG. 2, a home networking device 14 may be provided separately from the RBG 6 where the PC 4 on the home network is connected to the RBG 6 via the home networking device 14.

FIG. 3 illustrates one example of IP addressing applied to the network architecture of FIGS. 1-2. The RBG 6 includes a Dynamic Host Configuration Protocol (DHCP) server 16. The DHCP server 16 automatically assigns a unique private IP address (e.g. 192.68.0.2) to the PC 4, and assigns a unique private IP address (e.g. 192.68.0.1) to the interface on RBG 6 which connects the PC 4 and the RBG 6. The RBG 6 includes a forwarder 18 for passing traffic between the home network and the service provider network. The RBG 6 further includes a Network Address Translation (NAT) function 20 for concealing the private IP addresses of the home devices on the home network. The WAN connection 10 performs a physical interface carrying one L2 logical connection. The L2 circuit at the WAN connection 10 is terminated at the RBG 6, and is assigned a public IP address (e.g. 23.14.17.28) by the broadband service provider.

When the NAT function 20 receives IP traffic destined to the network from the PC 4, it translates the source IP address (e.g. 192. 68. 0.2) to the public IP address (e.g. 23.14.17.28). The IP traffic is sent by the forwarder 18 to its destination through the WAN connection 10. The forwarder 18 functions by using the destination IP address as a key for a look-up in its forwarding table. The forwarding table is a set of paired entries, with one portion of the pair being the destination IP address and the other portion being the L2 logical connection that is to be used to reach the destination address. The forwarding table entry for that destination address will direct the forwarder 18 to send the IP traffic out of the L2 logical connection on the WAN connection 10. When the reply comes back through the WAN connection 10, the forwarder 18 again looks-up the forwarding table entry for the destination IP address (in this case the IP address of the PC 4), the NAT function 20 translates the public IP address (e.g. 23.14.17.28) back to the private IP address (e.g. 192. 68. 0.1), and then the reply is sent back to the PC 4.

Broadband services have evolved to become a bundle of services, for example, by adding voice and video services to the traditional data service, as shown in FIG. 4. This bundle is commonly referred to as “Triple Play Services”. In FIG. 4, a TV 22, a PC 24 and a phone 26 are shown as examples of home devices on the home network. Each of the home devices 22, 24, and 26 communicate with a RBG 28 using a local connection (e.g. Ethernet). The RBG 28 includes a home networking device (not shown). The bundle of services is provided to the subscriber on the home network through the RBG 28.

FIG. 5 illustrates one example of IP addressing applied to the home network architecture of FIG. 4. The RBG 28 includes a DHCP server 30, a forwarder 32 and a NAT function 34. The DHCP server 30, forwarder 32 and NAT function 34 are similar to the DHCP server 16, forwarder 18 and NAT function 20 of FIG. 3, respectively. The home devices 22, 24 and 26 form a logical LAN, and each device (also known as a host) has its own private IP address (e.g. 192.68.0.4, 192.68.0.2, and 192.68.0.3), which had been previously assigned by the DHCP server 30.

As shown in FIG. 5, a network implementation that many service providers have been investigating includes multiple L2 circuits over the single L0/L1 connection to the home network. Each of the multiple L2 circuits terminated at the RBG 28 is used to carry traffic of a specific service type. In accordance with conventional IP addressing schemes, there is a 1:1 correspondence between any L2 logical connection (e.g. ATM PVCs, Ethernet VLAN, PPPoX session) and its IP address. In other words, the end-point of each L2 connection terminated on the RBG 28 facing the WAN network has its own unique public IP address. In FIG. 5, three L2 logical connections and their corresponding IP addresses (e.g. 23.14.17.28, 23.14.35.122, and 23.14.24.78) are shown. Thus, a single subscriber may consume many public IP addresses since one public IP address is required per L2 link per subscriber. To extend this to a large service provider network, for example, for one million subscribers, each having three L2 links supporting the three Triple Play services, three million public IP addresses must be provided by the service provider.

To ensure a 1:1 correspondence between any L2 logical connection and its IP address, the configuration and serving of multiple public IP addresses per subscriber becomes complex. Service Providers have various means to do this; one common example is the use of the Remote Authentication Dial-In User Service (RADIUS). Configuring and serving one public IP address to the subscriber for each service (e.g. each L2 connection) may require replication of these mechanisms in the service provider network. Further, since different public IP addresses are assigned to L2 connections and each supports a specific service, network and service troubleshooting will be complex.

Other service providers have been following a network design that maintains a single L2 connection from the WAN network to the home, and uses a more intelligent network element in or just behind the Access Node in the broadband network to separate traffic into different L2 connections. While this solution has no shortcomings at the RBG, it poses significant challenges and costs to the overall network architecture.

It is therefore desirable to provide a method and system for implementing an efficient and simple addressing scheme to provide multiple broadband services.

### SUMMARY OF THE INVENTION

It is an object of the invention to provide a method and system that obviates or mitigates at least one of the disadvantages of existing systems.

In accordance with an aspect of the present invention, there is provided a method for IP addressing, which includes the steps of: provisioning a plurality of logical connections to a broadband network; and associating a single IP address to the plurality of logical connections.

In accordance with a further aspect of the present invention, there is provided a system for IP addressing, which includes: a network gateway for provisioning a plurality of logical connections to a broadband network, the network gateway including an interface module for associating a single IP address to the plurality of logical connections.

This summary of the invention does not necessarily describe all features of the invention.

Other aspects and features of the present invention will be readily apparent to those skilled in the art from a review of the following detailed description of preferred embodiments in conjunction with the accompanying drawings.

### BRIEF DESCRIPTION OF THE DRAWINGS

These and other features of the invention will become more apparent from the following description in which reference is made to the appended drawings wherein:

FIG. 1 is a diagram showing a conventional home network architecture for providing a single broadband service to a home device;

FIG. 2 is a diagram showing a further conventional home network architecture for providing a single broadband service to a home device;

FIG. 3 is a diagram showing one example of IP addressing applied to the system of FIGS. 1-2;

FIG. 4 is a diagram showing a conventional home network architecture for Triple Play Services;

FIG. 5 is a diagram showing one example of IP addressing applied to the system of FIG. 4;

FIG. 6 is a diagram showing a home network architecture having a gateway to which IP addressing scheme in accordance with an embodiment of the present invention is applied;

FIG. 7 shows in a flowchart an example of a method of IP addressing in accordance with an embodiment of an IP interface module;

FIG. 8 is a diagram showing an example of the IP interface module of FIG. 6;

FIG. 9 shows in a flowchart an IP addressing operation where a scheme of assigning a unique IP address to each L2 connection is combined with some data structure;

FIG. 10 shows in a flowchart another example of an IP addressing operation using the IP interface module;

FIG. 11 is a diagram showing a broadband network architecture and a plurality of gateway devices to which IP addressing scheme of FIG. 6 is applied; and

FIG. 12 is a diagram showing an example of an RBG employed in FIG. 11.

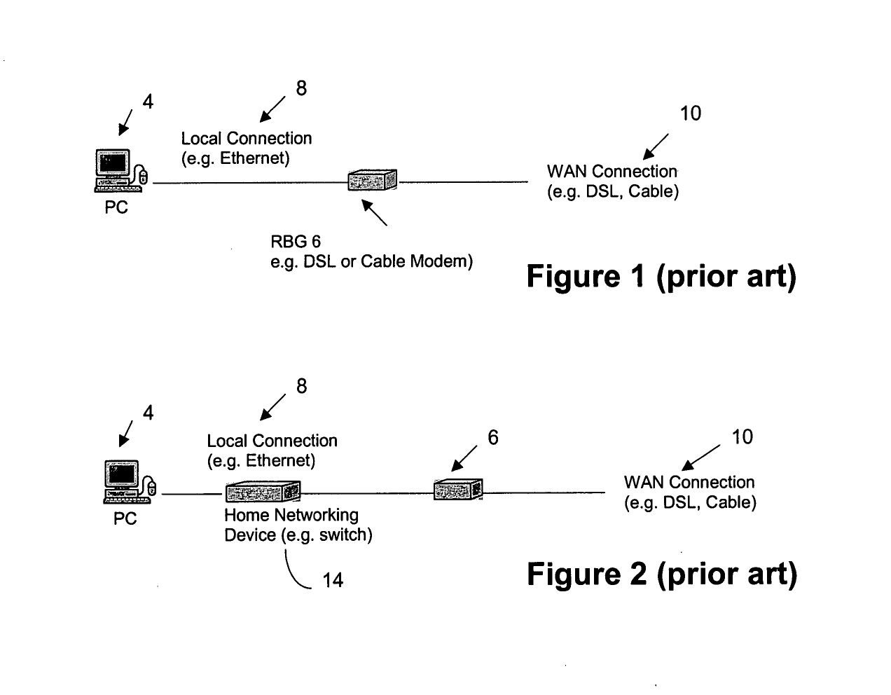

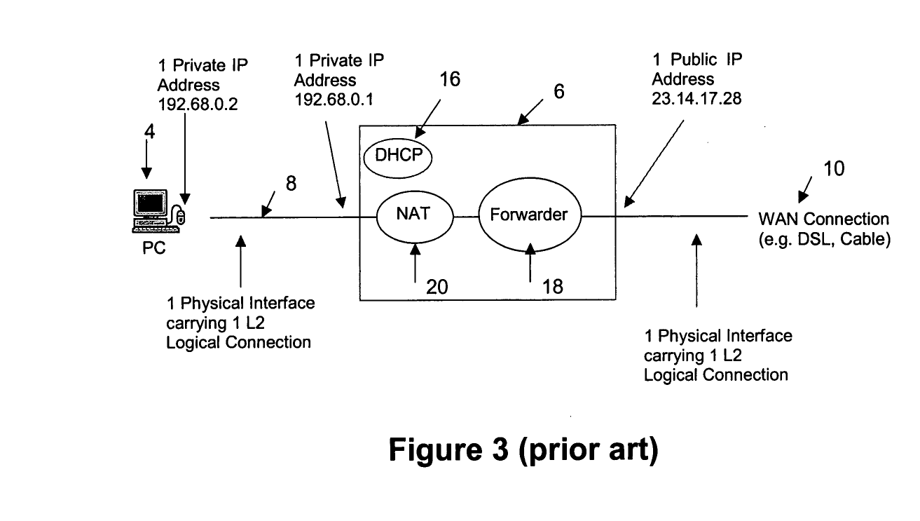

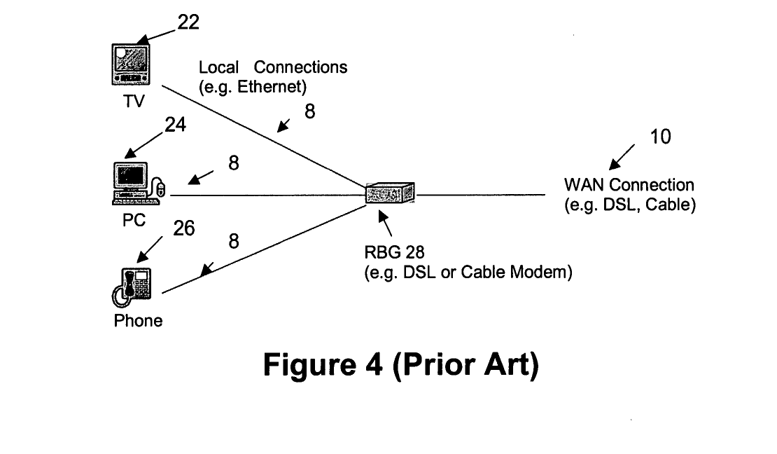

### DETAILED DESCRIPTION OF THE PREFERRED EMBODIMENT(S)

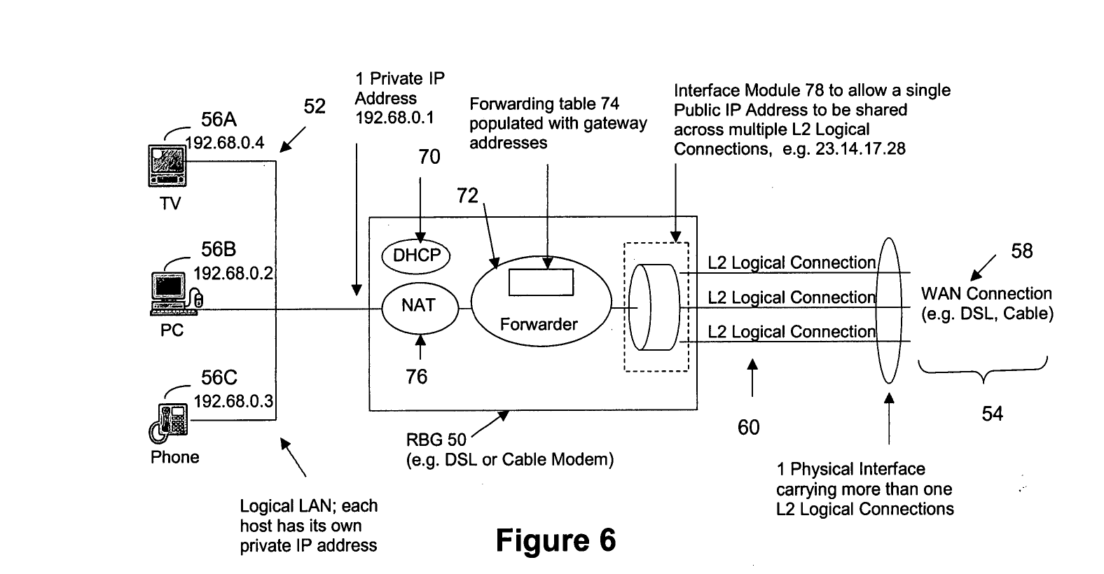

FIG. 6 illustrates a home network architecture having a gateway device 50 to which IP addressing scheme in accordance with an embodiment of the present invention is applied. The gateway device 50 serves as the connection point of a local network to a broadband network. In FIG. 6, one home network 52 (one subscriber) and one IP based broadband network 54 are shown as examples. The gateway device 50 may be a DSL modem, a cable modem, or some type of residential router, but is not limited to these three examples. In FIG. 6, a Residential Broadband Gateway (RBG) is shown as an example of the gateway device 50 (hereinafter referred to as RBG 50).

The RBG 50 allows the user of the home network 52 to access broadband services delivered through the broadband network 54. It is noted that in the description, “user”, “subscriber” and “customer” may be used interchangeably. The RBG 50 implements, for example, routing, bridging, quality of service and address translation (mapping) between the home network 52 and the IP based broadband network 54. The RBG 50 includes a home networking device (not shown). The home networking device in the RBG 50 may be, for example, an Ethernet switch with wired and/or wireless connections.

The home network 52 includes any number of home devices 56, including but not limited to, personal computers (PCs), TVs, set-top boxes, mobile devices, printers, faxes, Set-top Boxes, and VoIP devices, etc. These home devices are networked locally together using any home networking technology, and form a logical LAN. In FIG. 6, a TV 56A, a PC 56B, and a phone 56C are shown as examples of the home devices 56. However, the devices receiving broadband services through the RBG 50 are not limited to these three examples. Further, there is no limitation to the possible number of the home devices per one home network 52. The home network 52 may be any types of private networks such as networks for SOHO, education, and enterprise.

The broadband network 54 may include any type of broadband (for example, but not limited to, DSL or cable) that a service provider uses to deliver multiple services to the subscriber and user of the home network 52. The multiple services provided by the service provide may include Triple Play services. In FIG. 6, the broadband network 54 includes a WAN connection 58. The WAN connection 58 may be, but not limited to, a DSL or cable broadband connection. Alternatively, the RBG 50 may connect the home network 52 and the broadband network 54 through a wireless communication.

In the WAN connection 58, one physical interface carries a group of L2 logical connections or links 60. As described below, the end-points of all of the L2 connections 60 terminated on the RBG 50 facing the WAN network share a single IP address. This group of L2 logical connections 60 is used as a single IP interface by the RBG 50. It is noted that in the description, “connection” may be a single instance of a L2 logical link capable of carrying a stream of packets. It is noted that in the description, “interface” may be the IP interface enabling IP traffic running over a layer 2 media over a single physical channel. A user message (e.g., frame, packet) from the broadband network 54 or the home network 52 is encapsulated in a networking protocol frame that includes a logical connection identifier (e.g., Ethernet VLAN identifier or ATM PVC ID).

Each of the L2 logical connections 60 may be used to carry traffic of a specific service type. The L2 logical connections 60 may support the Triple play services. The logical interface may transmit the packet along with forwarding-class (FC)/service class (SC) information. In FIG. 6, three L2 logical connections 60 are shown. However, there is no limitation to the possible number of the L2 connections at the WAN connection 58.

The RBG 50 is described in detail. The RBG 50 includes a DHCP server 70, a forwarder 72 containing a forwarding table 74, a NAT function 76, and an IP interface module 78 for utilizing a single public IP address for a plurality of L2 logical connections.

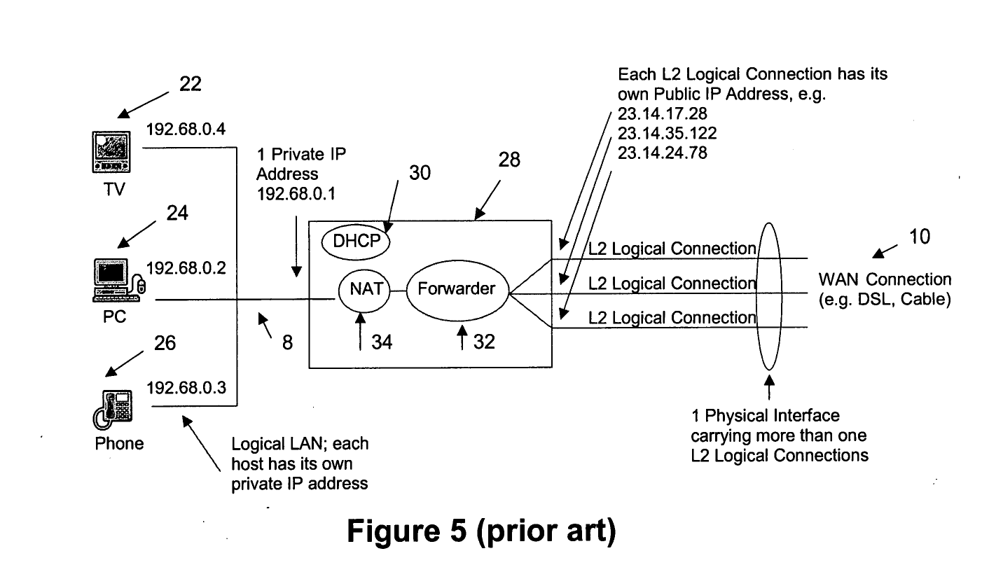

The DHCP server 70 may be similar to the DHCP server 30 of FIG. 5. The DHCP server 70 automatically assigns a unique private IP address to each of the home devices, e.g. 192.68.0.2, 192.68.0.3, 192.68.0.4. The DHCP server 70 also automatically assigns a unique private IP address (e.g. 192.68.0.1) to the interface on RBG 50, through which the home devices communicate with the RBG 50.

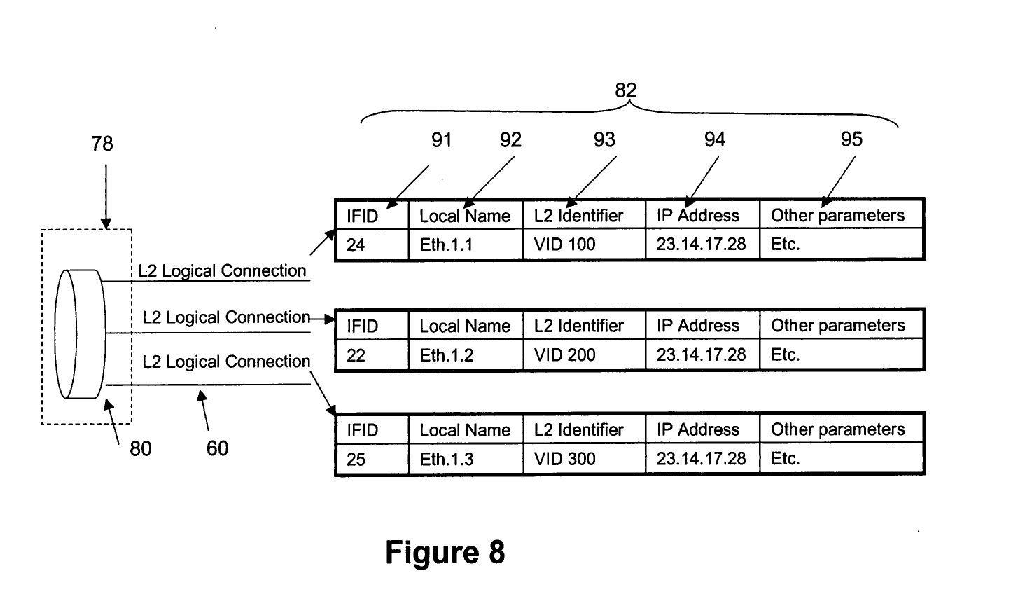

The forwarder 72 is provided for passing traffic between the home network and the broadband network by using the destination IP address as a key to look up the egress connection in the forwarding table 74. The egress connection is usually denoted in the forwarding table by, for example, Local Name (e.g. 92 of FIG. 8). The forwarding table 74 is populated with forwarding entries, including one or more gateway addresses, by a service provider. The service provider may utilize TR-069, which is the DSL Forum's CPE WAN management protocol, or other protocol methods to populate the forwarding table 74 with forwarding entries.

The NAT function 76 may be similar to the NAT function 34 of FIG. 5. The NAT function 76 conceals the private IP addresses of the home devices on the home network. The NAT function 76 translates a private IP address to the single public IP address and translates the single public IP address to the private IP address.

The IP interface module 78 is described in detail. The IP interface module 78 includes a module for obtaining a single public IP address for the L2 logical connections. The single public IP address is shared across the L2 logical connections 60. The single public IP address is associated in a 1: N manner to the N L2 logical connections (N: integer). For example, the three L2 logical connections 60 shown in FIG. 6 share a single IP address of (23.14.17.28). The IP interface module 78 is shown in FIG. 6 to indicate that the L2 logical connections have been provisioned as described below. Once the L2 logical connections are provisioned, the IP interface module 78 has no further impact on the forwarding of message traffic.

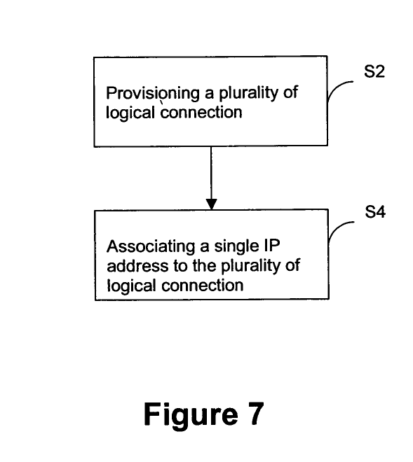

FIG. 7 illustrates in a flowchart an example of a method of IP addressing in accordance with an embodiment of the IP interface module 78. At step S2, the IP interface module 78 provisions a plurality of logical connections (e.g., logical connections 60 of FIG. 6) to a broadband network (e.g., 54 of FIG. 6). At step S4, the IP interface module 78 associates a single IP address to the plurality of logical connections. In FIG. 7, the IP interface module 78 provisions more than one logical connections, and then associates the single IP address to the plurality of logical connections. However, the IP interface module 78 may provision one logical connection and then associate the single IP address to the one logical connection. The step of provisioning (S2) may include creating a logical connection. In the description, the terms “provisioning” and “creating” are used interchangeably.

FIG. 8 illustrates an example of the IP interface module 78 of FIG. 6. Referring to FIG. 8, the IP interface module 78 allows a single IP interface 80 that has a single public IP address (e.g. 23.14.17.28) to be used by multiple L2 logical connections 60. The multiple L2 logical connections 60 are multiplexed on to a single physical line and kept logically separate by a L2 Identifier, e.g. an Ethernet VLAN ID. The IP interface module 78 may be instantiated in either the firmware or software of the RBG 50.

The IP interface module 78 populates one or more data structures 82, each of which defines the corresponding L2 logical connection 60. Each of the data structures 82 may include a group of fields of information for the corresponding L2 logical connection to define that L2 logical connection. In this example, the group of fields for each L2 logical connection includes an Interface Identifier field (IFID) 91, a local name field 92, a L2 identifier field 93 and an IP address field 94. Further, as shown in FIG. 7, one or more fields 95 for any other parameter(s) may be included in the data structure.

The IFID 91 is a field that contains the interface identifier for the corresponding L2 logical connection that is unique within the scope of the RBG 50 of FIG. 6. Each L2 logical connection on the RBG 50 will have a different value for the IFID.

The Local Name 92 is a field that contains the local name of the L2 logical connection that is unique within the scope of the RBG 50. Each L2 logical connection on the RBG 50 will have a different value for the Local Name.

The L2 Identifier 93 is a field that contains the value of the multiplexing label for the L2 logical connection. In this example, Ethernet VLAN Identifiers are used to multiplex a plurality of L2 logical connections 60 on to the same physical connection. The value of the L2 Identifier will be unique within the scope of the physical connection.

The IP Address 94 is a field that contains the IP address assigned to this L2 logical connection.

The one or more fields 95 for other parameter(s) contain additional information related to the instantiation of the L2 logical connection 60. These fields 95 may identify bandwidth or traffic management parameters, but are not limited to those.

Each data structure may contain some or all of these fields 91-95, and are not limited to these examples. There is no implied limit to the amount of information contained in the data structure 82. The above example uses five fields for illustrative purposes only.

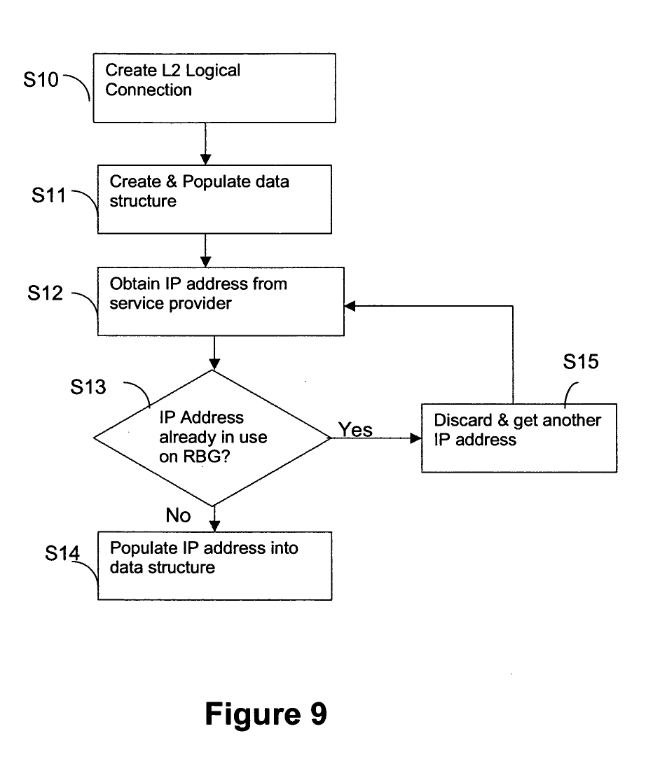

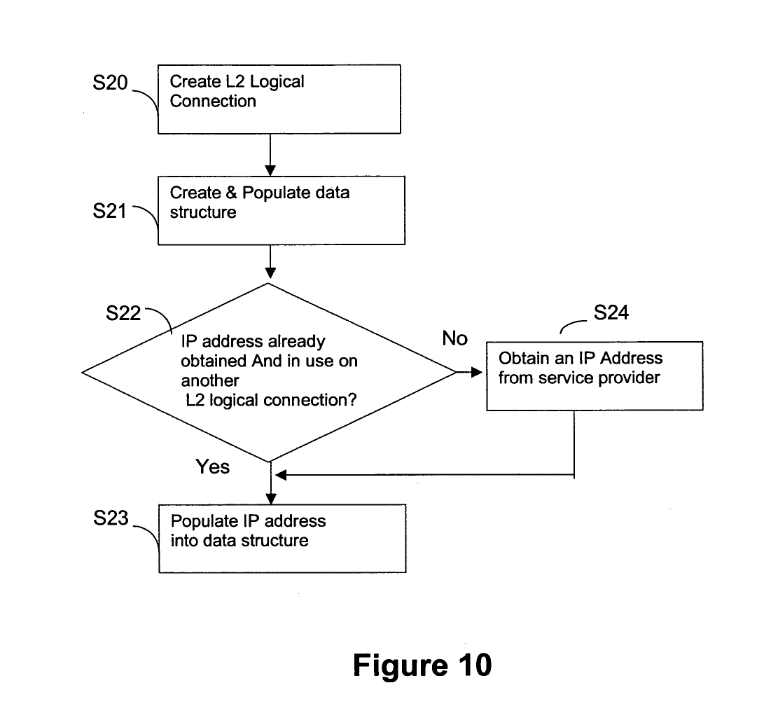

FIG. 9 illustrates in a flowchart an IP addressing operation where a scheme of assigning a unique IP address to each L2 connection is combined with some data structure. It is assumed that this operation is implemented on the RBG 28 of FIG. 5. Referring to FIGS. 5 and 9, in order to create a L2 logical connection (step S10), the firmware and/or software of the RBG 28 creates and populates the data structure (step S11). One entry in the data structure is the IP address. Thus, the RBG 28 must obtain an IP address from somewhere, in this example, from the service provider (step S12). A check must be made to see if this IP address is already in use by the RBG 28 (step S13). If yes, the IP address is discarded (step S15) and the RBG 28 must obtain another IP address from the service provider (step S12) to assign a unique public IP address to each L2 connection. When the RBG 28 obtains an IP address and that IP address does not match any of the IP addresses which the RBG 28 have been already using (step S13), the data structure is populated with that new IP address (step S14).

When applying the conventional scheme to the data structures 82 of FIG. 8, the data structures 82 are constrained to have a 1:1 relationship between the IFID 91 field and the IP Address 94 field. In other words, each L2 logical connection was constrained to have a unique IP address. No two (or more) L2 logical connections could have the same IP address.

By contrast, the IP interface module 78 of FIGS. 6 and 8 removes this constraint and allows two or more L2 logical connections (as implemented in their data structures) to have the same IP Address value.

FIG. 10 illustrates in a flowchart another example of IP addressing operation using the IP interface module 78 of FIGS. 6 and 8. Referring to FIGS. 6, 8 and 10, the firmware and/or software of the RBG 50 creates a L2 logical connection in response to a broadband service provisioning step (step S20). A data structure (82 of FIG. 8) is created (step S21) for this L2 logical connection If the IP interface module 78 already has an IP address from a service provider (step S22), it can be used and is placed into the new data structure (82 of FIG. 8) (step S23). If the IP address interface 78 does not have any IP address, the IP interface module 78 would request and obtain one from the service provider (step S24).

Referring to FIG. 6, when the NAT function 76 receives IP traffic from the home device (e.g. 56B), it translates the source IP address (e.g. 192. 68. 0.1) into the single public IP address (e.g. 23.14.17.28) based on the NAT function 76 configuration. The IP traffic is sent by the forwarder 72 to its destination through the WAN connection 60. The forwarder 72 functions by using the destination IP address as a key for a look-up in the forwarding table 74 to obtain the egress L2 connection, generally listed by its Local Name (an entry in the L2 connection data structure 82). The forwarding table entry for that destination address will direct the forwarder 72 to send the IP traffic to a specific L2 logical connection on the WAN connection 60. When the reply comes back through the WAN connection 60, the forwarder 72 again looks-up the forwarding table entry 74 for the destination address, the NAT function 76 translates the public IP address (e.g. 23.14.17.28) back to the private IP address (e.g. 192. 68. 0.2), and then the reply is sent back to the corresponding home device (e.g. 56B).

Policy-based or standard routing can be used to direct traffic upstream over the appropriate Layer 2 connection as before. An example of policy-based routing may be if the forwarder 72 of the RBG 50 has been configured to send all traffic received from the home network 52 with a certain Ethernet VLAN ID onto a specific L2 logical connection. Standard routing may have the forwarder look in its forwarding table 74 for the destination address, and forward the traffic to the L2 logical connection specified in the table 74 corresponding to the destination address. From the broadband network 54, the elements forward traffic to the RBG 50 as before, in most cases not even aware that other elements are also connected to the same RBG, through different L2 logical connections but using the same IP address.

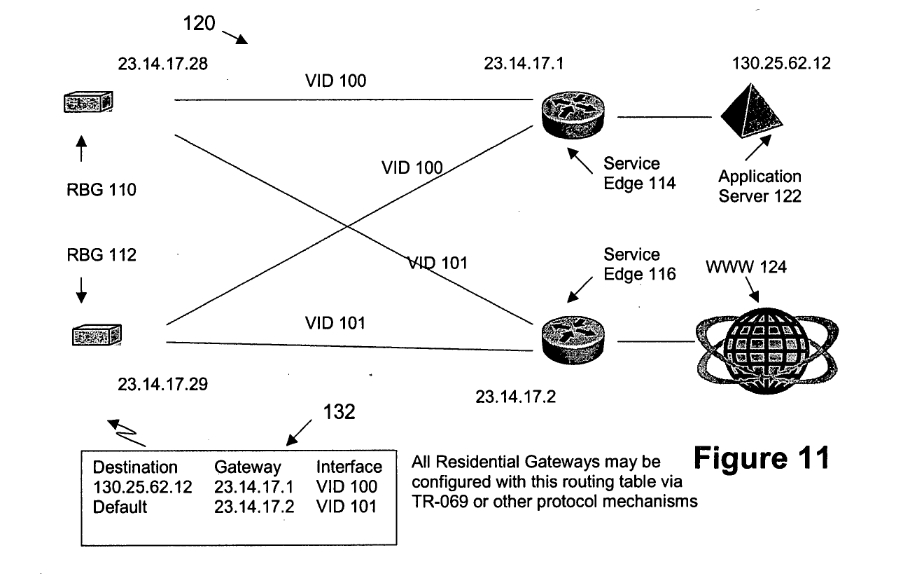

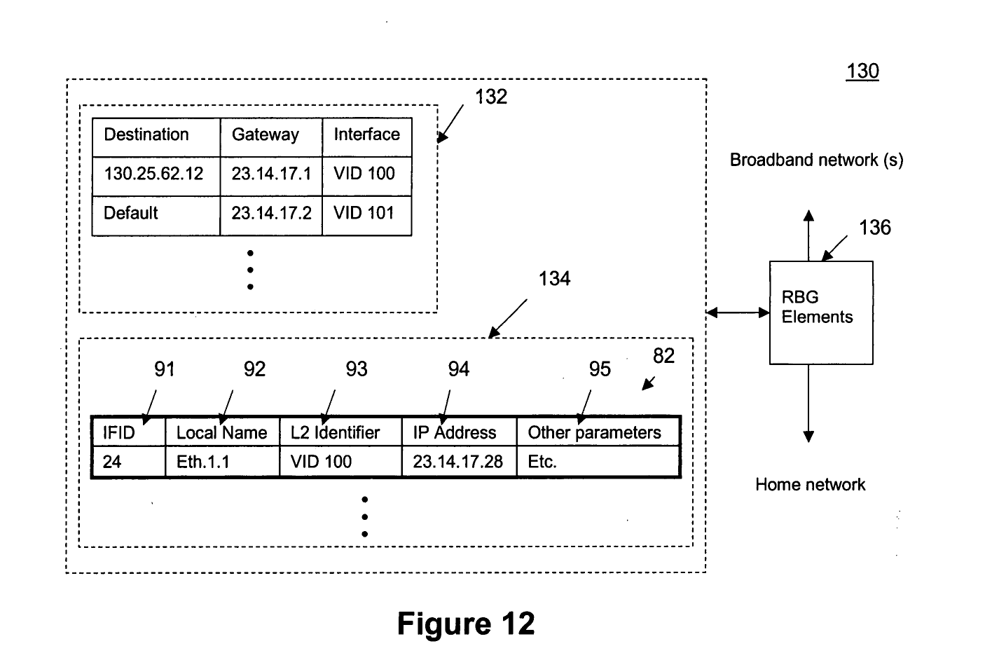

FIG. 11 illustrates a diagram showing a broadband network architecture and a plurality of residential broadband gateway devices to which the IP addressing scheme of FIG. 6 is applied. A plurality of home networks (not shown in FIG. 11) are connected to a broadband network 120 through a plurality of residential broadband gateway devices. In FIG. 11, RBGs 110 and 112 are shown as examples of the residential broadband gateway devices. The RBGs 110 and 112 serve as the connection point of the home networks (not shown in FIG. 11) to the broadband network 120.

The RBGs 110 and 112 may be similar to the RBG 50 of FIG. 6. The home network connected to the RBG 110 or 112 may be similar to the home network 52 of FIG. 6. In FIG. 11, two home networks (not shown) are connected to the broadband network 120, one through the RBG 110 and the other through the RBG 112. However, there is no limitation of the possible number of the RBGs and the home networks. All RBGs may be configured with a routing table (132) via TR-069 or other protocol mechanism.

The broadband network 120 may be similar to the broadband network 54 of FIG. 6. In FIG. 11, the broadband network 120 includes services shown by an application server 122 and World Wide Web (WWW) 124. In FIG. 11, two service edge routers 114 and 116 are shown as examples of the access points to broadband services. However, there is no limitation of the possible number of the service edge routers. The service edge router 114 is connected to the application server 120. The service edge router 116 is connected to the World Wide Web (WWW) 124. The two service edge routers 114 and 116 are the destinations within the broadband network 120 where services are accessed. Home devices (e.g. 56A-56C of FIG. 6) access broadband services through the RBGs 110 and 112 and the service edge routers 114 and 116.

FIG. 12 illustrates an example of an RBG applicable to RBGs 110 and 112 of FIG. 11. Referring to FIG. 12, RBG 130 of FIG. 12 includes a forwarding table 132 and a data structure 134. The forwarding table 132 of each RBG is similar to the forwarding table 74 of FIG. 6. The data structure 134 of each RBG may be similar to the data structure 82 of FIG. 8, and is populated for each L2 logical connection by, for example, the IP interface module 78 of FIG. 6. RBG elements 136 may receive traffic from the home network with a destination IP address of 130.25.62.12 and use this as a key to look up the egress connection from the forwarding table 132. The forwarding table entry for destination IP address 130.25.62.12 indicates that the traffic must go to the gateway service edge router with IP address 23.14.17.1 (service edge router 114 in FIG. 11), which is reachable through the L2 connection with VID 100. The data structure 134 with VID 100 is found and indicates, to the RBG, which L2 connection to use, and the RBG 130 then transmits the traffic to the destination.

Referring to FIGS. 11 and 12, the single public IP address is associated in a 1: N manner to the N L2 logical connections (N: integer). In this example, both RBGs 110 and 112 have two L2 logical connections, identified by VID 100 and VID 101. A plurality of L2 logical connections on each RBG share a single public IP address assigned to that RBG.

For example, a single public IP address (e.g. 23.14.17.28) is assigned to the RBG 110, while a single public IP address (e.g. 23.14.17.29) is assigned to the RBG 112, each RBG having obtained unique IP addresses from the service provider. The RBG 110 has one physical connection to the broadband network 120 that carries two L2 logical connections (VID 100, VID 101). The L2 logical connection identified by VID 100 connects the RBG 110 to the service edge router 114. The L2 logical connection identified by VID 101 connects the RBG 110 to the service edge router 116. Both of these L2 logical connections use the same IP address (23.14.17.28) at their end-points on the RBG 110. Similarly, the RBG 112 has one physical connection to the broadband network 120 that carries two L2 logical connections (VID 100, VID 101). The L2 logical connection identified by VID 100 connects the RBG 112 to the service edge router 114. The L2 logical connection identified by VID 101 connects the RBG 112 to the service edge router 116. Both of these L2 logical connections use the same IP address (23.14.17.29) at their end-points on the RBG 112.

It is noted that the IP addressing of FIGS. 6-8 and 10-12 may be extended for use at a service edge. It is noted that the mapping entity for the IP addressing in FIG. 11 may be extended for use at a service edge.

According to the embodiments of the present invention, the IP addressing scheme enables conservation of IP addresses by consuming only one IP address per subscriber instead of one IP address per logical connection. It achieves (#L2 connections−1)/(#L2 connections)=% reduction in the number of IP addresses consumed. For example, typical broadband networks support millions of subscribers. In the conventional system, for a one million subscriber network, with three L2 connections each, three million IP addresses are required. By contrast, according to the embodiments of the present invention, one million IP addresses only are used. Thus, a 66% reduction can be achieved in this example in the number of IP addresses required.

Further, the IP addressing scheme enables simplified configuration and service provisioning. Since it can provide operations and equipment to support serving IP addresses over one connection, it will reduce the replication of these activities to a single instance. Service providers will only have to support the configuration and serving of IP addresses over a single L2 logical connection to the home. Only one instance of the systems (e.g. RADIUS servers) is required to support this activity; in the prior art, an instance of the system would be required for every L2 logical connection to the home. This reduction from a multiple to a single instance of the systems enables simpler and lower cost implementations of these systems in the service provider network.

Further, the service provider only has to configure one IP address per customer, not per logical connection per customer. It poses significant operational cost savings to the service provider. The service provider may use a single Layer 2 connection for all authentication, address assignment, and service authorization tasks. The service provider only needs to support the equipment and operation to do so at one service edge behind a single Layer 2 connection, and not at every service edge, leading to significant operational and capital savings.

Further, the IP addressing scheme simplifies network and service troubleshooting. One IP address is associated with a single customer, where before each customer had many IP addresses. Customer issues can be resolved through analysis of a single IP address.

The IP addressing scheme in accordance with the embodiments of the present invention described above may be implemented by any hardware, software, a firmware or combinations thereof having the above described functions. The software code, either in its entirety or a part thereof, may be stored in a computer readable memory. Further, a computer data signal representing the software code, which may be embedded in a carrier wave may be transmitted via a communication network. Such a computer readable memory and a computer data signal are also within the scope of the present invention, as well as the hardware, software and the combination thereof.

The present invention has been described with regard to one or more embodiments. However, it will be apparent to persons skilled in the art that a number of variations and modifications can be made without departing from the scope of the invention as defined in the claims.

What is claimed is:

1. A method for IP addressing, comprising the steps of:
provisioning a plurality of logical connections to a broadband network; and
associating a single IP address to the plurality of logical connections.

2. The method according to claim 1, wherein the step of provisioning includes the step of:
initiating a first logical connection of the plurality of logical connections.

3. The method according to claim 2, wherein the step of associating includes the steps of:
assigning the single IP address to the first logical connection; and
storing the association of the single IP address and the first logical connection.

4. The method according to claim 3, wherein the step of provisioning further includes the step of:
initiating a new logical connection of the plurality of logical connections.

5. The method according to claim 4, wherein the step of associating includes the steps of:
assigning the single IP address to the new logical connection; and
storing the association of the single IP address and the new logical connection.

6. The method according to claim 5, wherein the step of provisioning includes the step of:
determining if there are any logical connections in the plurality of logical connections that are already associated with the IP address.

7. The method according to claim 1, wherein the step of provisioning includes the step of:
provisioning a logical connection of the plurality of logical connections to a broadband service of the broadband network.

8. The method according to claim 1, wherein the step of provisioning includes the step of:
determining if there are any logical connections in the plurality of logical connections that are associated with an IP address.

9. The method according to claim 1, wherein the step of associating includes the step of:
storing an association between a logical connection of the plurality of logical connections and the single IP address.

10. The method according to claim 1, further comprising the step of:
associating a home network to the plurality of logical connections.

11. The method according to claim 10, further comprising the steps of:
receiving a network message from the home network; and
sending the network message to the broadband network.

12. The method according to claim 11, further comprising the step of:
determining a logical connection identifier associated with a destination of the network message.

13. The method according to claim 10, further comprising the steps of:
receiving a network message from the broadband network; and
sending the network message to the home network.

14. The method according to claim 11, further comprising the steps of:
determining a home network associated with a destination of the network message.

15. A system for IP addressing comprising:
a network gateway for provisioning a plurality of logical connections to a broadband network, the network gateway including an interface module for associating a single IP address to the plurality of logical connections.

16. The system according to claim 15, wherein the interface module includes:
a repository for storing the association between the single IP address to a logical connection.

17. The system according to claim 16, further comprising a data structure stored in the repository, the data structure for defining the association between the single IP address and the plurality of logical connections.

18. The system according to claim 17, wherein the data structure includes for each logical connection in the plurality of logical connections:
an IP address field for storing the single IP address; and
an identifier field for storing a logical connection identifier.

19. The system according to claim 15, wherein the gateway includes:
a module for provisioning a logical connection to a broadband service.

20. The system according to claim 15, further comprising:
a forwarding table for associating a logical connection of the plurality of logical connections with a broadband service of the broadband network.

21. The system according to claim 20, further comprising:
a forwarder for receiving a network message from a home network and for sending the network message to the broadband network through the single IP address.

22. The system according to claim 15, further comprising:
a forwarding table for associating destination IP addresses to the plurality of logical connections.

23. The system according to claim 20, further comprising:
a forwarder for receiving a network message from the broadband network and for sending the network message to a home network utilizing the home network IP address.

24. The system according to claim 15, further comprising at least one of:
a DHCP server for assigning a unique private IP address to each home device in a home network and for assigning a unique private IP address to an end point facing the home network, and
a NAT function module for concealing the private IP address from the broadband network.

25. The system according to claim 15, wherein the system includes at least one of a residential broadband gateway, a router, a DSL modem, a cable modem, a residential router, and a home networking device.

26. The system according to claim 15, wherein the broadband network provides Triple Play Services.
